(19) United States
(12) Patent Application Publication
(10) Pub. No.: US 2012/0120424 A1
(43) Pub. Date: May 17, 2012

(54) COLOR CONVERSION METHOD, COLOR CONVERSION APPARATUS, AND IMAGE FORMING SYSTEM

(75) Inventor: Sachiko HIRANO, Hino-shi (JP)

(73) Assignee: Konica Minolta Business Technologies, Inc., Chiyoda-ku (JP)

(21) Appl. No.: 13/295,506

(22) Filed: Nov. 14, 2011

(30) Foreign Application Priority Data
Nov. 15, 2010 (JP) 2010-254484

(51) Int. Cl. H04N 1/60

(52) U.S. Cl. 358/1.9

(57) ABSTRACT

A color conversion method that converts a spot color into a combination of a plurality of output-color values corresponding to output colors generated by an image forming apparatus, the method including: acquiring a name of the spot color; a category of the spot color, the category being one of a plurality of categories into which spot colors are classified; and an input-color value of the spot color; for each spot color; selecting a color conversion table corresponding to the acquired category out of a plurality of color conversion tables stored beforehand in a storage unit for the respective categories, each of the color conversion tables indicating a correspondence relationship between the input-color value and the combination of the output-color values; and converting the acquired input-color value into the combination of the output-color values based upon the selected color conversion table.

### BACKGROUND OF THE INVENTION

1. Field of the Invention

The present invention relates to a color conversion method, a color conversion apparatus, and an image forming system.

2. Description of Related Art

Conventionally, in an image forming apparatus such as a copying machine or a printer, an image is formed based upon data of output colors (cyan (C), magenta (M), yellow (Y), and black (K)), on which a color conversion has been performed, generated by the image forming apparatus.

In a printing industry, there is a case where a spot color is designated from a color chart such as a DIC color guide (registered trademark). In this case, when a general color conversion is performed on a spot color, it might be difficult to bring the resultant close to a target color.

In view of this, there has been proposed a color adjusting method in which a color conversion is performed on a spot color outside a color reproduction range of a printer, which color conversion is different from that for a process color outside the color reproduction range (see Japanese Patent Application Laid-Open No. 2004-88217).

There has also been proposed a color matching method in which a color conversion for a spot color is performed with a color conversion table different from a conversion table for an ordinary color (see Japanese Patent Application Laid-Open No. 2010-10862).

However, spot colors include characteristic colors from the viewpoint of texture and visual effects, such as fluorescent colors (generally including a component that converts ultraviolet light into visible light and emits the resultant light), metallic colors (generally including microparticles causing reflection like metal). Therefore, if a color conversion is performed on the whole spot color with the use of one color conversion table based on the chromatic value of a spot color when the spot color is converted into CMYK values that correspond to output colors generated by the image forming apparatus, the resultant might become different from its visual impression due to the influence of emitted light or reflected light.

In order to bring a color formed by the image forming apparatus close to its visual impression, an adjustment and correction have to be made. However, adjusting and correcting CMYK values of a spot color individually needs skills and takes time and labor. In addition, there is a problem that, when only a specific color is adjusted, levels of brightness, contrast, or hue of spot colors that are similar to each other might be reversed.

### SUMMARY OF THE INVENTION

The present invention is made in view of the above-mentioned problems of the background technique. An object of the present invention is to perform an appropriate color conversion on a spot color.

According to a first aspect of the present invention, there is provided a color conversion method that converts a spot color into a combination of a plurality of output-color values corresponding to output colors generated by an image forming apparatus, the method including: acquiring a name of the spot color; a category of the spot color, the category being one of a plurality of categories into which spot colors are classified; and an input-color value of the spot color; for each spot color; selecting a color conversion table corresponding to the acquired category out of a plurality of color conversion tables stored beforehand in a storage unit for the respective categories, each of the color conversion tables indicating a correspondence relationship between the input-color value and the combination of the output-color values; and converting the acquired input-color value into the combination of the output-color values based upon the selected color conversion table.

According to a second aspect of the present invention, there is provided a color conversion apparatus that converts a spot color into a combination of a plurality of output-color values corresponding to output colors generated by an image forming apparatus, the color conversion apparatus including: a storage unit that stores a plurality of color conversion tables for a plurality of categories, into which spot colors are classified, each of the color conversion tables indicating a correspondence relationship between an input-color value and the combination of the output-color values; and a control unit that acquires a name of the spot color, a category of the spot color, and the input-color value of the spot color, for each spot color; selects a color conversion table corresponding to the acquired category out of the plurality of color conversion tables stored in the storage unit; and converts the acquired input-color value into the combination of the output-color values based upon the selected color conversion table.

According to a third aspect of the present invention, there is provided an image forming system including: an image forming apparatus; and a color conversion apparatus that converts a spot color into a combination of a plurality of output-color values corresponding to output colors generated by the image forming apparatus, the color conversion apparatus including: a storage unit that stores a plurality of color conversion tables for a plurality of categories, into which spot colors are classified, each of the color conversion tables indicating a correspondence relationship between an input-color value and the combination of the output-color values; a control unit that acquires a name of the spot color, a category of the spot color, and the input-color value of the spot color, for each spot color; selects a color conversion table corresponding to the acquired category out of the plurality of color conversion tables stored in the storage unit; and converts the acquired input-color value into the combination of the output-color values based upon the selected color conversion table; and a transmission unit that transmits the combination of the output-color values after a color conversion to the image forming apparatus.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a diagram illustrating a configuration of an image forming system;

FIG. 2 is a block diagram illustrating a functional configuration of a client personal computer (PC);

FIG. 3 is a block diagram illustrating a functional configuration of a printer controller;

FIG. 4A illustrates an example of a color conversion table for fluorescent colors;

FIG. 4B illustrates an example of a color conversion table for metallic colors;

FIG. 4C illustrates an example of a color conversion table for general spot colors;

FIG. 5 is a view illustrating changed values of brightness of fluorescent colors;

FIG. 6 is a view illustrating changed values of hue angles of fluorescent colors;

FIG. 7 is a view illustrating changed values of brightness of metallic colors;

FIG. 8 illustrates an example of a color separation table;

FIG. 9 is a flowchart illustrating a first color separation table creating process according to a first embodiment;

FIG. 10 is a flowchart illustrating a second color separation table creating process according to a second embodiment;

FIG. 11 is a flowchart illustrating a first color conversion process according to a third embodiment;

FIG. 12 is a flowchart illustrating a second color conversion process according to a fourth embodiment;

FIGS. 13-15 are tables showing results of examinations to determine preferable changed values of brightness of fluorescent colors;

FIGS. 16-18 are tables showing results of examinations to determine preferable changed values of hue angles of fluorescent colors; and

FIGS. 19-21 are tables showing results of examinations to determine preferable changed values of brightness of metallic colors.

### DESCRIPTION OF THE PREFERRED EMBODIMENTS

### First Embodiment

A color conversion method according to a first embodiment of the present invention will firstly be described.

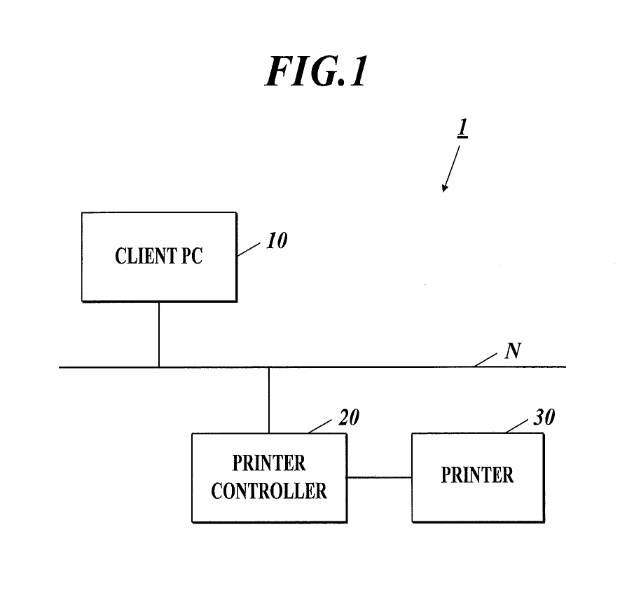

FIG. 1 is a diagram illustrating a configuration of an image forming system 1. As illustrated in FIG. 1, the image forming system 1 includes a client personal computer (PC) 10, a printer controller 20 serving as a color conversion apparatus, and a printer 30 serving as an image forming apparatus. The client PC 10 and the printer controller 20 are connected to each other so as to be capable of performing data communication through a communication network N. The printer controller 20 and the printer 30 are connected to each other via a dedicated interface bus. The printer controller 20 may be incorporated in the printer 30.

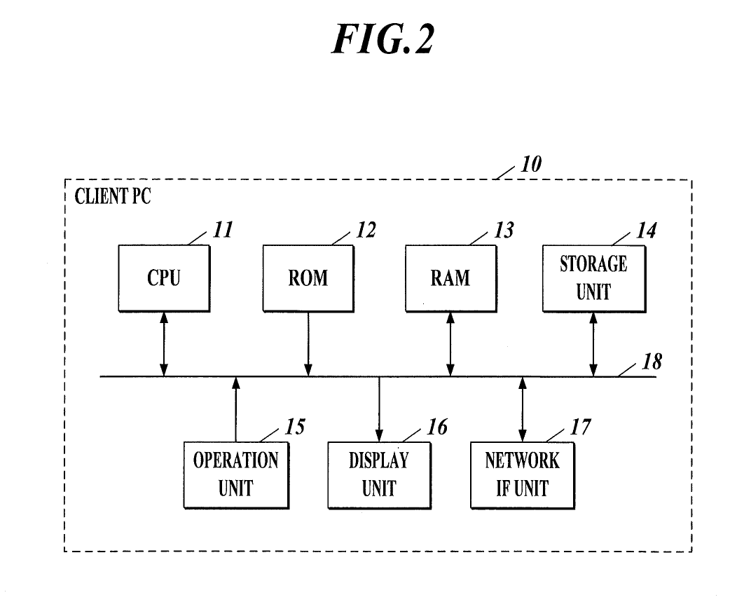

FIG. 2 is a block diagram illustrating a functional configuration of the client PC 10. As illustrated in FIG. 2, the client PC 10 includes a central processing unit (CPU) 11, a read only memory (ROM) 12, a random access memory (RAM) 13, a storage unit 14, an operation unit 15, a display unit 16, and a network interface (IF) unit 17, which units are connected with each other via a bus 18.

The CPU 11 comprehensively controls the operations of the respective units in the client PC 10. The CPU 11 reads various processing programs stored in the ROM 12 or the storage unit 14 according to an operation signal input through the operation unit 15 or an instruction signal received from the network IF unit 17, and develops the read programs on the RAM 13 so as to execute various processes in cooperation with the corresponding programs.

The ROM 12, which is composed of a non-volatile semiconductor memory or the like, stores a control program and parameters and files etc. needed for the execution of the program.

The RAM 13 forms a work area that temporarily stores various processing programs executed by the CPU 11 and data involved with these programs.

The storage unit 14, which includes a storage device such as a hard disk, stores various processing programs and data involved with the various processes.

The operation unit 15, which includes a keyboard having cursor keys, character input keys, and various function keys; and a pointing device such as a mouse, accepts an operation input by a user. The operation unit 15 outputs an operation signal, input through a key operation on the keyboard or a mouse operation, to the CPU 11.

The display unit 16, which has a liquid crystal display (LCD), displays various operation screens or results of various processes in accordance with an instruction from the CPU 11.

The network IF unit 17 sends and receives data to and from an external device through the communication network N. For example, the network IF unit 17 transmits data about a spot color (such as a name or category of a spot color) or image data to the printer controller 20.

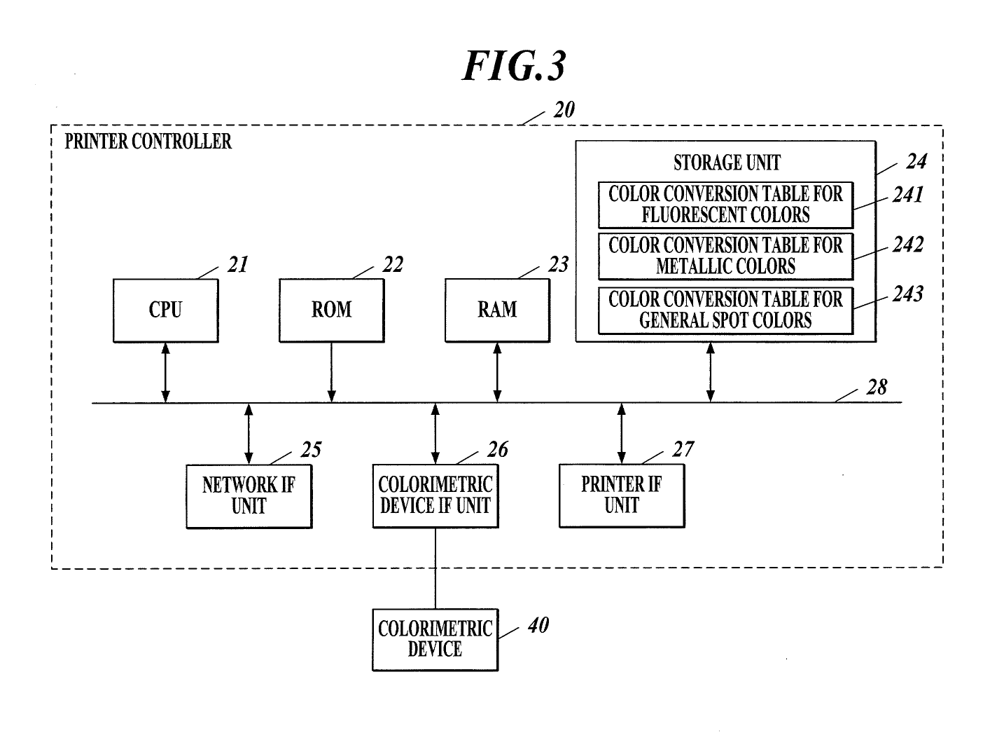

FIG. 3 is a block diagram illustrating a functional configuration of the printer controller 20. As illustrated in FIG. 3, the printer controller 20 includes a CPU 21, a ROM 22, a RAM 23, a storage unit 24, a network IF unit 25, a colorimetric device IF unit 26, and a printer IF unit 27, which units are connected with each other with a bus 28.

The CPU 21 comprehensively controls the operations of the respective units in the printer controller 20. The CPU 21 reads various processing programs stored in the ROM 22 according to an instruction signal received from the network IF unit 25, and develops the read programs on the RAM 23 so as to execute various processes in cooperation with the corresponding programs.

The ROM 22, which is composed of a non-volatile semiconductor memory or the like, stores a control program and parameters and files etc. needed for the execution of the program.

The RAM 23 forms a work area that temporarily stores various processing programs executed by the CPU 21 and data involved with these programs.

The storage unit 24, which includes a storage device such as a hard disk, stores various data pieces. There are a plurality of categories into which spot colors are classified. The storage unit 24 stores a color conversion table for fluorescent colors 241, a color conversion table for metallic colors 242, and a color conversion table for general spot colors 243, for the respective categories. There are three categories for spot colors: a category composed of fluorescent colors, a category composed of metallic colors, and a category composed of general spot colors. A general spot colors indicate spot colors other than the fluorescent colors and metallic colors. The general spot color is used as a “predetermined spot color” that is a comparison standard when the color conversion table for fluorescent colors 241 and the color conversion table for metallic colors 242 are created. The storage unit 24 also stores a color conversion table for general process colors other than the spot colors.

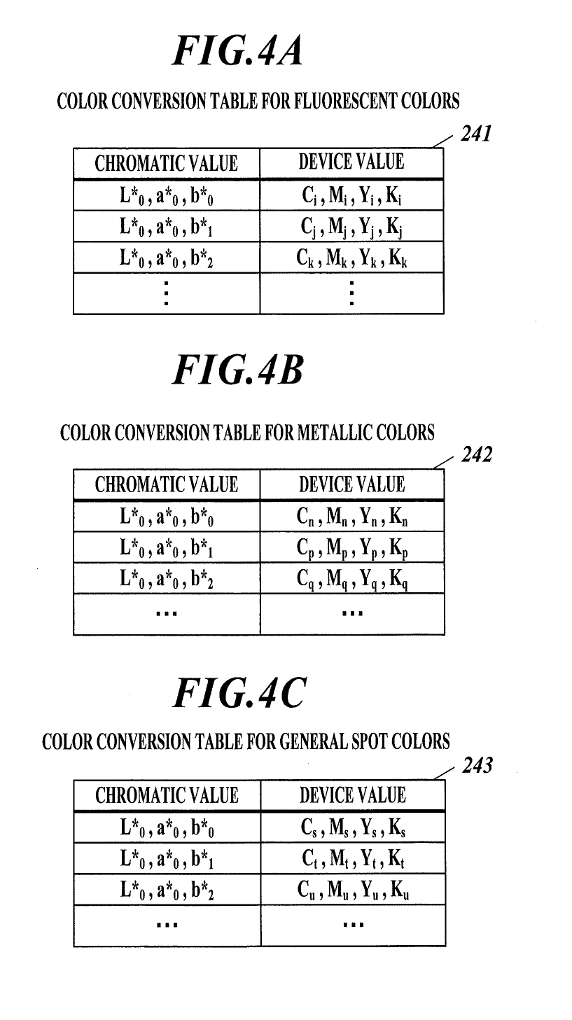

FIGS. 4A, 4B, and 4C respectively illustrate examples of the color conversion table for fluorescent colors 241, the color conversion table for metallic colors 242, and the color conversion table for general spot colors 243. These color conversion tables 241, 242, and 243 are substantially equal to BtoA table of ICC device profile, wherein a combination (hereinafter referred to as a device value) (CMYK value) (output-color values) of a plurality of colors corresponding to output colors generated by the printer 30 is associated with a chromatic value (L*a*b*) (input-color value). The respective color conversion tables 241, 242, and 243 discretely store chromatic values and device values. A device value corresponding to a chromatic value of the whole color space can be obtained by an interpolation calculation.

The color conversion table for fluorescent colors 241 is a color conversion table used for outputting an ink color containing fluorescent pigments in the printer 30. A fluorescent color is far off from a color gamut that is reproducible by an electrophotography, and has a change in a wavelength of a reflection light caused by a fluorescent substance. Therefore, when a color conversion is performed on a fluorescent color using the general color conversion table, the resultant is too dark, and an effect of hue is also different depending upon a color. In consideration with this, the color conversion table for fluorescent colors 241 is prepared.

The color conversion table for metallic colors 242 is a color conversion table used for outputting an ink color containing metallic powders in the printer 30. When a color conversion is performed on a metallic color using the general color conversion table, the resultant is too dark, due to an influence of reflection light on a visual contact. In consideration with this, the color conversion table for metallic colors 242 is prepared.

The color conversion table for general spot colors 243 is used for the conversion in which a color difference between an input chromatic value and a colorimetric value of a color formed by the printer 30 is minimized within a range where a hue angle is substantially not changed. A BtoA table creating process in a creation of a known printer profile can be used for creating the color conversion table for general spot colors 243. In particular, a BtoA table creating process in colorimetric rendering intent is preferably used.

At least one of brightness and hue of a color, which is generated by the printer 30 based upon a device value obtained by converting the same chromatic value, is different within a predetermined color range depending on which of the color conversion tables 241, 242 and 243 is used. Specifically, it is not necessary that the color conversion tables 241, 242 and 243 produce color conversion results different from each other for all colors. The respective color conversion tables 241, 242 and 243 may produce the color conversion results that are partially different from each other.

It is supposed that the brightness is made different between the color conversion tables 241, 242 and 243. When the same chromatic value is input, for example, the range, in which a conversion is made such that the brightness L* of a color formed by the printer 30 based upon a device value after the conversion is made different by 2 to 15 (more preferably, 2 to 6), is set under the condition that the brightness L* of the input chromatic value is 5 or more.

It is supposed that the hue is made different between the color conversion tables 241, 242 and 243. When the same chromatic value is input, for example, the range, in which a conversion is made such that the hue h, on a*b* plane, of a color formed by the printer 30 based upon a device value after the conversion is made different by 3 to 25 degrees (more preferably, 3 to 15 degrees), is set under the condition that the hue h of the input chromatic value is 3 degrees or more.

It is preferable that a color conversion is performed such that brightness of a color obtained by using the color conversion table for fluorescent colors 241 is higher than brightness of a color obtained by using the color conversion table for general spot colors 243 within a predetermined color range, when the colors are generated by the printer 30 based upon the device values obtained by converting the same chromatic value. For example, the color conversion table for fluorescent colors 241 is configured so that the range, where a conversion is made such that the brightness L* of the color formed based on the device value after the conversion is increased by 2 to 15 (preferably 2 to 6) when the same chromatic value is input, is set under the condition that the brightness L* of the input chromatic value is 5 or more. In particular, the brightness L* becomes higher for a color outside the color gamut.

More specifically, a color conversion result using the color conversion table for fluorescent colors 241 corresponds to the color conversion result using the color conversion table for general spot colors 243 after the brightness L* of an input chromatic value is changed by ±0 when the brightness L* is equal to or less than LK0, changed by LK2 when the brightness L* is LK1 (>LK0), changed by LK4 when the brightness L* is LK3 (or the smaller one of LK3 and the value obtained by subtracting LK4 from the brightness L* of a device white point) (>LK1), and changed by ±0 when the brightness L* is at the device white point (a linear interpolation is performed between brightnesses). The device white point indicates a color (white paper) of a sheet used in the printer 30. It is to be noted that the following equations are satisfied: LK0=40 to 54, LK1=55 to 65, LK2=+2 to +6, LK3=70 to 90, and LK4=+2 to +6.

A method of examining the optimum values of LK0 to LK4 will be described here.

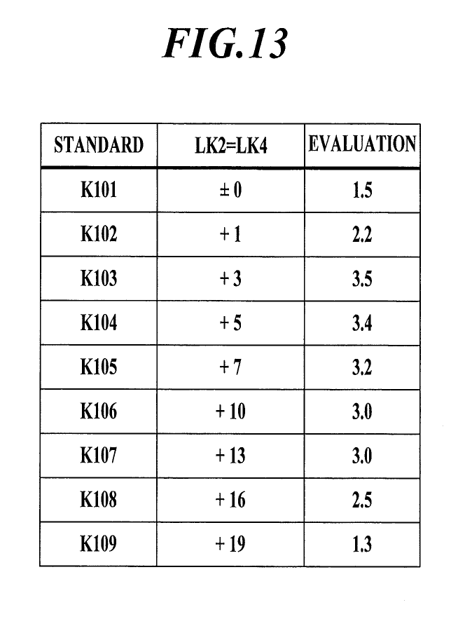

Firstly, it is determined to what degree the brightness L* of an input chromatic value is to be increased. Chromatic values were measured for 10 fluorescent spot colors in a “COLOR FINDER (registered trademark)” made by Toyo Ink Mfg. Co., Ltd. (registered trademark) by a measuring device of Eye-One manufactured by X-Rite, Incorporated. (registered trademark). Setting was performed such that LK0=the darkest device color, LK1=the darkest device color+LK2, LK3=device white color−LK4 (the range covers substantially all brightness regions), and LK2=LK4. A color conversion was performed on the measured chromatic values in such a manner that the set values were changed by using bizhub (registered trademark) PRO C6500 as the printer 30, and the resultants were output. The output products were compared to patches of COLOR FINDER, and the desirability in color reproduction of each output was evaluated on a scale of 1 to 5. Here, 5 was the best, 1 was the worst, and 3 or more was specified as an approximate of an allowable level for practical use. The average of the results made by five experienced color adjusters was calculated (the value was rounded off to the first decimal place). FIG. 13 shows the result.

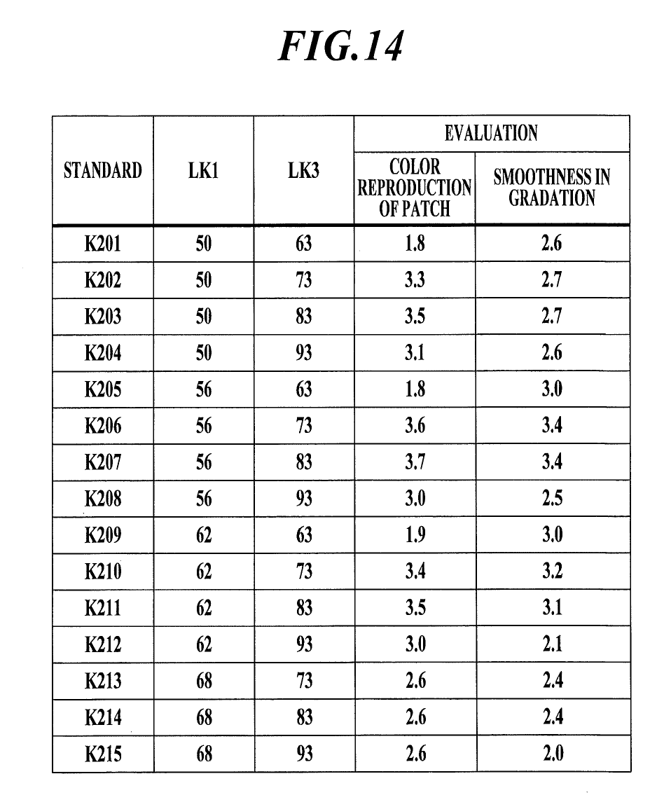

Then, it is determined which range of the brightness L* is to be increased. Under the condition same as the above-mentioned condition, an equation of LK2=LK4=4 was fixed, and LK1 and LK3 were changed. With this condition, a color conversion was performed on 10 fluorescent spot colors and a gradation chart from white to black (created with CKYK data), and the resultants were output. The smoothness in the color change in the gradation chart was evaluated on a scale of 1 to 5 (for confirming whether a gradation connection is appropriate as a whole or not as a result of the conversion even when a chromatic value that is different from a general fluorescent spot color is input). FIG. 14 shows this result.

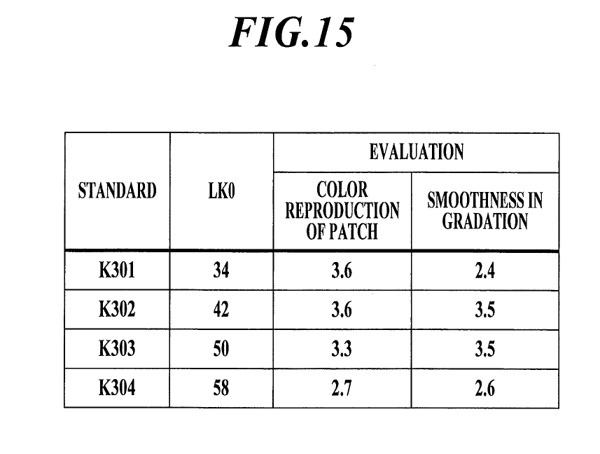

The evaluation similar to that described above was performed, wherein equations of LK1=60 and LK3=78 were further fixed, and LK0 was changed under the condition same as the above-mentioned condition. FIG. 15 shows this result.

From the results described above, the numerical ranges described above were determined as the effective and non-defective ranges.

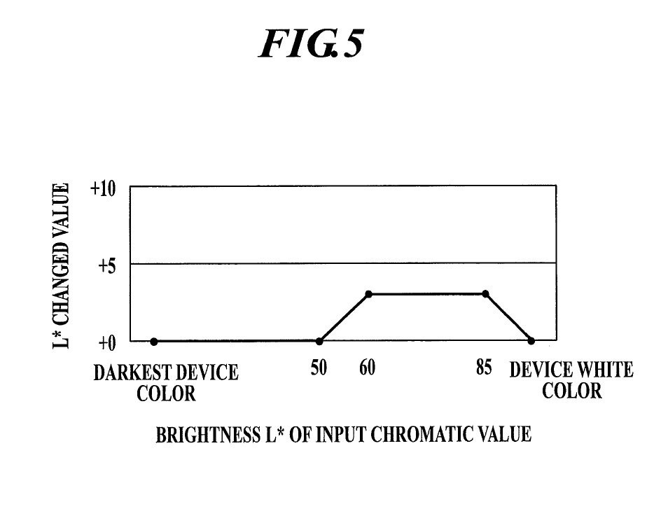

FIG. 5 is a view illustrating changed values of brightness L* of fluorescent colors, when the process using the color conversion table for fluorescent colors 241 is divided into changing of the brightness L* and the process using the color conversion table for general spot colors 243. FIG. 5 illustrates an example in which the equations of LK0=50, LK1=60, LK2=+3, LK3 (or smaller one of LK3 and a value obtained by subtracting 3 from the device white point L*)=85 and LK4=+3 are satisfied.

It is preferable that a color conversion is performed such that a hue angle of a color obtained by using the color conversion table for fluorescent colors 241 is larger than a hue angle of a color obtained by using the color conversion table for general spot colors 243 within a predetermined color range, when the colors are generated by the printer 30 based upon the device values obtained by converting the same chromatic value. For example, the color conversion table for fluorescent colors 241 is configured so that the range, where the conversion is made such that the hue angle h on the a*b* plane of the color based on the device value after the conversion is increased by 3 to 25 degrees(preferably 3 to 15 degrees) within a region of −50 to 10 degrees wherein +a* direction is specified as 0 degree, +b* direction is specified as +90 degrees, and −b* direction is specified as −90 degrees, when the same chromatic value is input, is set under the condition that the hue angle h of the input chromatic value is 3 degrees or more. In particular, the hue angle h becomes higher for a color outside the color gamut.

More specifically, the color conversion result using the color conversion table for fluorescent colors 241 corresponds to a color conversion result using the color conversion table for general spot colors 243 after the hue angle h of an input chromatic value on the a*b* plane is changed by ±0 when the hue angle h is h0 degree, changed by h2 degree when the hue angle h is h1 (>h0 degree), changed by h4 degree when the hue angle h is h3 (>h1 degree), and changed by ±0 when the hue angle h is h5 (>h3) degree (a linear interpolation is performed between hue angles) under the condition that the +a* direction is specified as 0 degree, +b* direction is specified as +90 degrees, and −b* direction is specified as −90 degrees. It is to be noted that the following equations are satisfied: h0=−55 to −45, h1=−40 to −20, h2=+3 to +15, h3=−20 to 0, h4=+3 to +15, and h5=+5 to +15.

A method of examining the optimum values of h0 to h5 will be described here.

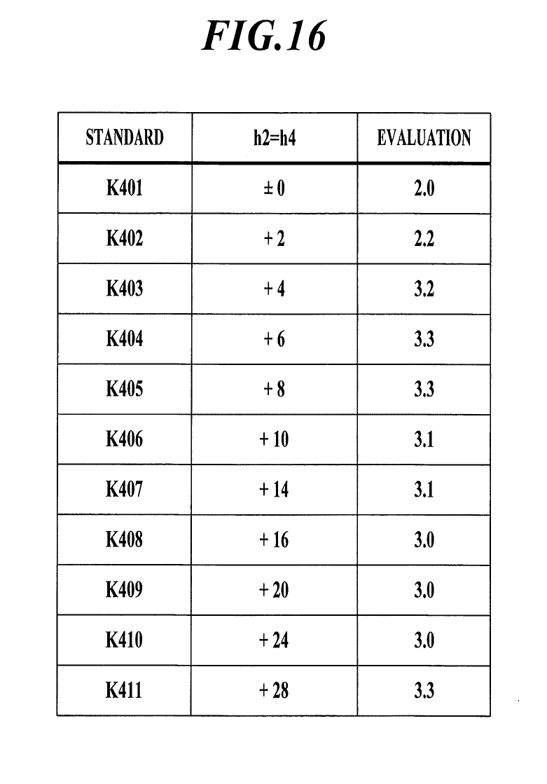

Firstly, it is determined to what degree the hue angle h of an input chromatic value is to be increased. Chromatic values were measured for 10 fluorescent spot colors in a “COLOR FINDER” made by Toyo Ink Mfg. Co., Ltd. by a measuring device of Eye-One manufactured by X-Rite, Incorporated. Setting was performed such that LK2=LK4=4, LK1=60, LK3=78, LK0=45, h0=−90, h1=h0+(2*h2), h3=h5−(2*h2), h5=+90, and h2=h4. A color conversion was performed on the measured chromatic values in such a manner that the set values were changed by using bizhub PRO C6500 as the printer 30, and the resultants were output. The output products were compared to patches of COLOR FINDER, and the desirability in color reproduction of each output was evaluated on a scale of 1 to 5. Here, 5 was the best, 1 was the worst, and 3 or more was specified as an approximate of an allowable level for practical use. The average of the results made by five experienced color adjusters was calculated (the value was rounded off to the first decimal place). FIG. 16 shows the result.

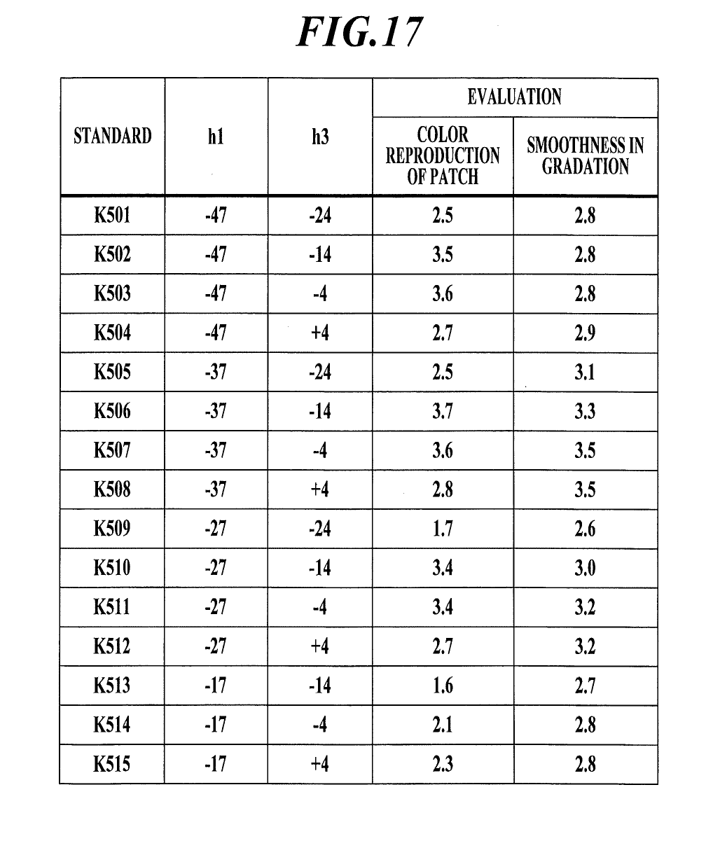

Then, it is determined which range of the hue angle h is to be increased. Under the condition same as the above-mentioned condition, equations of h2=h4=4, h0=h1−12, and h5=h3+12 were fixed, and h1 and h3 were changed. With this condition, a color conversion was performed on 10 fluorescent spot colors and the gradation chart, and the resultants were output. The gradation chart was changed in the form of C to B to M to R to Y to G to C, and it was created with CKYK data. B (blue) is C+M, R (red) is M+Y, and G (green) is Y+C. The smoothness in the color change in the gradation chart was evaluated on a scale of 1 to 5 (for confirming whether a gradation connection is appropriate as a whole or not as a result of the conversion even when a chromatic value that is different from a general fluorescent spot color is input). FIG. 17 shows the result.

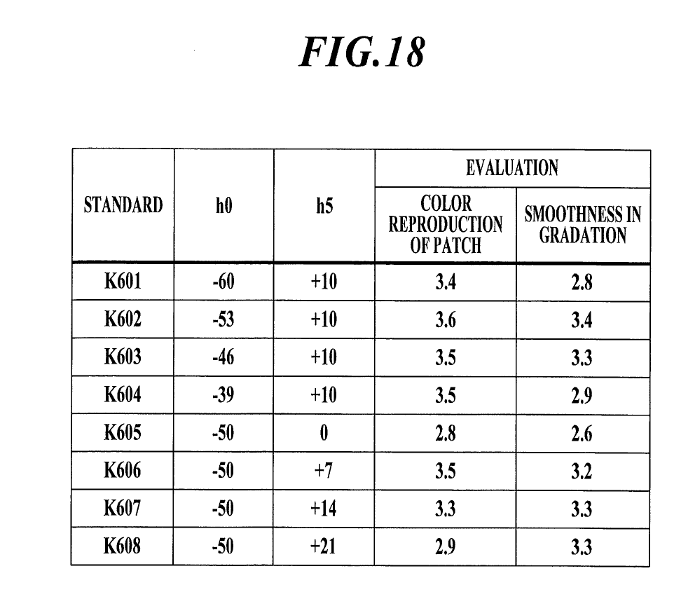

The evaluation similar to that described above was performed, wherein equations of h1=−30 and h3=−5 were further fixed, and h0 and h5 were changed under the condition same as the above-mentioned condition. FIG. 18 shows the result.

From the results described above, the numerical ranges described above were determined as the effective and non-defective ranges.

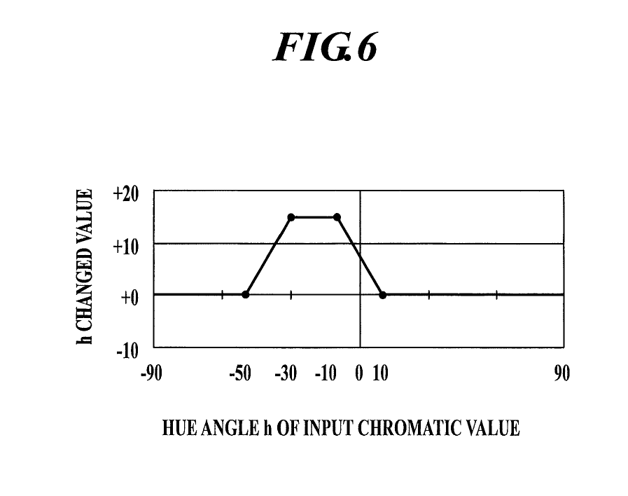

FIG. 6 is a view illustrating changed values of hue angles h of fluorescent colors, when the process using the color conversion table for fluorescent colors 241 is divided into changing of the hue h and the process using the color conversion table for general spot colors 243.

FIG. 6 illustrates an example in which the equations of h0=−50, h1=−30, h2=+15, h3=−10, h4=+15, and h5=10 are satisfied.

Further, it is preferable that a color conversion is performed such that brightness of a color obtained by using the color conversion table for metallic colors 242 is higher than brightness of a color obtained by using the color conversion table for general spot colors 243 within a predetermined color range, when the colors are generated by the printer 30 based upon the device values obtained by converting the same chromatic value. For example, the color conversion table for metallic colors 242 is configured so that the range, where the conversion is made such that the brightness L* of the color formed based on the device value after the conversion is increased by 2 to 15 (preferably 2 to 6) when the same chromatic value is input, is set under the condition that the brightness L* of the input chromatic value is 5 or more. In particular, the brightness L* becomes higher for a color within the color gamut.

More specifically, the color conversion result using the color conversion table for metallic colors 242 corresponds to a color conversion result using the color conversion table for general spot colors 243 after the brightness L* of an input chromatic value is changed by ±0 when the brightness L* is equal to or less than LM0, changed by LM2 when the brightness L* is LM1 (>LM0), changed by LM4 when the brightness L* is LM3 (or the smaller one of LM3 and the value obtained by subtracting LM4 from the brightness L* of a device white point) (>LM1), and changed by ±0 when the brightness L* is at the device white point (a linear interpolation is performed between brightnesses). It is to be noted that the following equations are satisfied: LM0=25 to 35, LM1=40 to 60, LM2=+2 to +6, LM3=65 to 85, and LM4=+2 to +6.

A method of examining the optimum values of LM0 to LM4 will be described here.

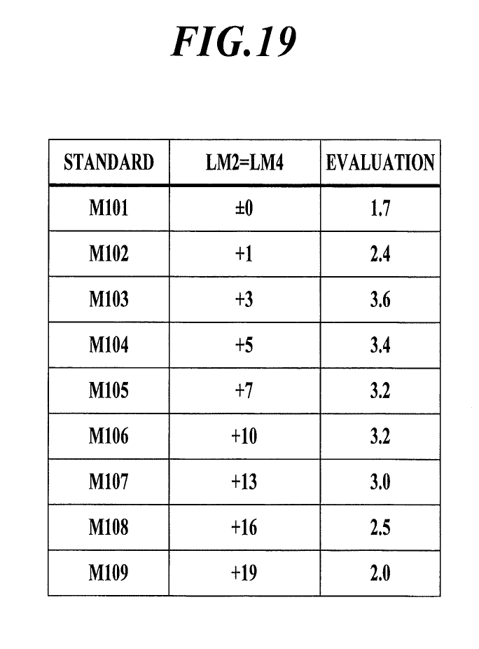

Firstly, it is determined to what degree the brightness L* of an input chromatic value is to be increased. Chromatic values were measured for 24 metallic spot colors in a “COLOR FINDER” made by Toyo Ink Mfg. Co., Ltd. by a measuring device of Eye-One manufactured by X-Rite, Incorporated. Setting was performed such that LM0=the darkest device color, LM1=the darkest device color+LM2, LM3=device white color−LM4 (the range covers substantially all brightness regions), and LM2=LM4. A color conversion was performed on the measured chromatic values in such a manner that the set values were changed by using bizhub PRO C6500 as the printer 30, and the resultants were output. The output products were compared to patches of COLOR FINDER, and the desirability in color reproduction of each output was evaluated on a scale of 1 to 5. Here, 5 was the best, 1 was the worst, and 3 or more was specified as an approximate of an allowable level for practical use. The average of the results made by five experienced color adjusters was calculated (the value was rounded off to the first decimal place). FIG. 19 shows the result.

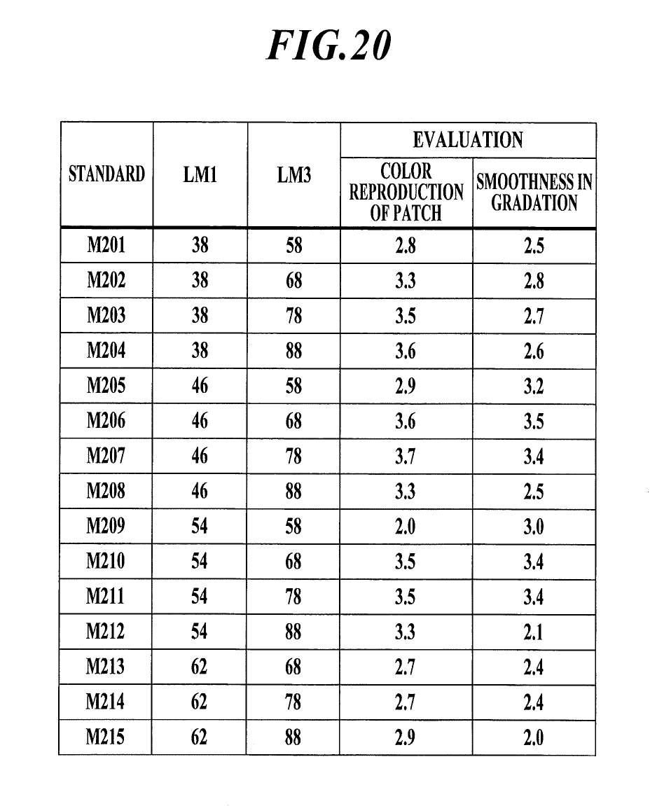

Then, it is determined which range of the brightness L* is to be increased. Under the condition same as the above-mentioned condition, an equation of LM2=LM4=4 was fixed, and LM1 and LM3 were changed. With this condition, a color conversion was performed on 24 metallic spot colors and a gradation chart from white to black (created with CKYK data), and the resultants were output. The smoothness in the color change in the gradation chart was evaluated on a scale of 1 to 5 (for confirming whether a gradation connection is appropriate as a whole or not as a result of the conversion even when a chromatic value that is different from a general metallic spot color is input). FIG. 20 shows the result.

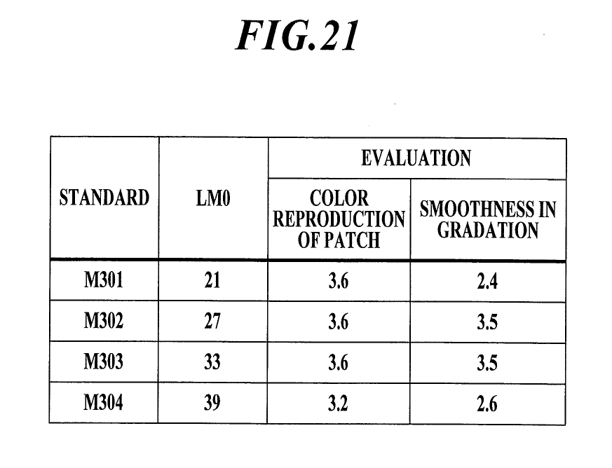

The evaluation similar to that described above was performed, wherein equations of LM1=50 and LM3=73 were further fixed, and LM0 was changed under the condition same as the above-mentioned condition. FIG. 21 shows the result.

From the results described above, the numerical ranges described above were determined as the effective and non-defective ranges.

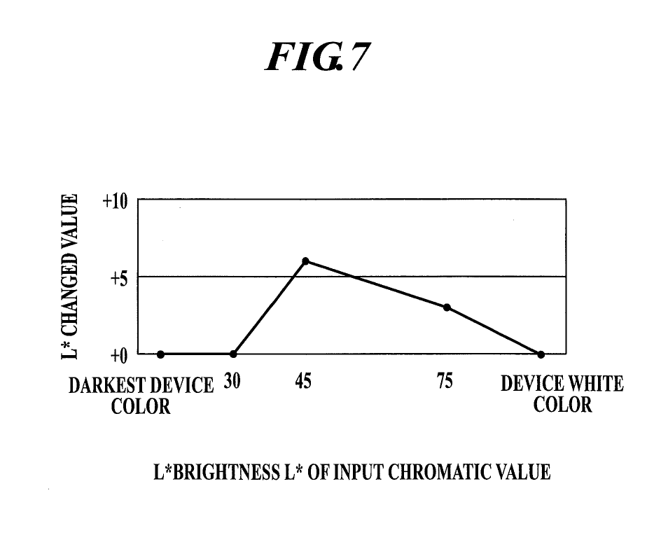

FIG. 7 is a view illustrating changed values of brightness L*, when the process using the color conversion table for metallic colors 242 is divided into changing of the brightness L* and the process using the color conversion table for general spot colors 243. FIG. 7 illustrates an example in which the equations of LM0=30, LM1=45, LM2=+6, LM3 (or smaller one of LM3 and a value obtained by subtracting 3 from the brightness L* of the device white point)=75, and LM4=+3 are satisfied.

The network IF unit 25 sends and receives data to and from an external device through the communication network N. For example, the network IF unit 25 receives data about a spot color (such as a name or category of a spot color) or image data from the client PC 10.

The colorimetric device IF unit 26 receives colorimetric data (chromatic value) from the calorimetric device 40. The calorimetric data is expressed by a color system such as L*a*b*, or XYZ, which is not dependent upon a device.

The printer IF unit 27 inputs and outputs data to and from the printer 30. The printer IF unit 27 transmits image data (CMYK value) after the color conversion to the printer 30.

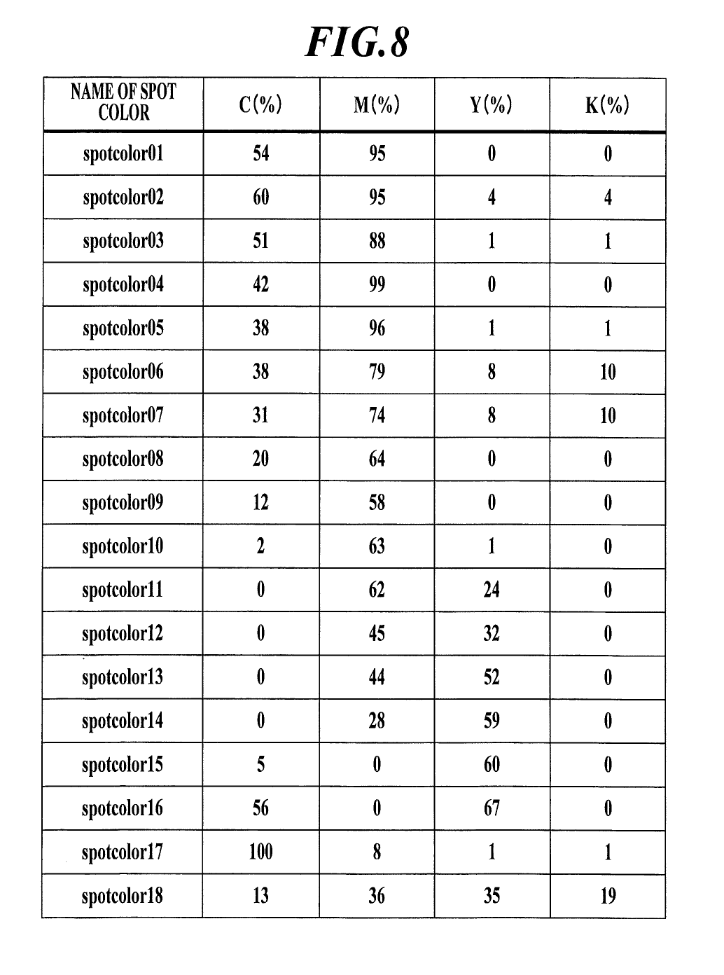

The CPU 21 acquires the name of a spot color, the category of the spot color, and the chromatic value of the spot color, for each spot color, in cooperation with the program stored in the ROM 22; selects a color conversion table, out of a plurality of color conversion tables stored in the storage unit 24 corresponding to the category of the spot color; and converts the chromatic value of the spot color into a device value based upon the selected color conversion table. The CPU 21 then creates a color separation table in which the name of a spot color and the device value corresponding to the spot color are associated with each other. FIG. 8 illustrates an example of the color separation table. The color separation table is also referred to as a spot color table, spot color library, or the like. In general, the color separation table is prepared in the form of a plurality of types of lists, such as a list according to a color chart series (DIC color guide and the like), a list according to an ink manufacturer, or a list according to a user's original version.

The printer 30 is an image forming apparatus that forms an image onto a sheet based upon image data (CMYK value), on which a color conversion has been performed, and which is received from the printer controller 20. For example, the printer 30 makes an image formation according to an electrophotographic system. The printer 30 includes a photosensitive drum, a charging unit for charging the photosensitive drum, an exposure unit that exposes and scans the surface of the photosensitive drum based upon image data, a developing unit that deposits toner onto the photosensitive drum, a transfer unit that transfers a toner image formed on the photosensitive drum onto a print sheet, and a fixing unit that fixes the toner image formed on the print sheet.

An operation according to the first embodiment will next be described.

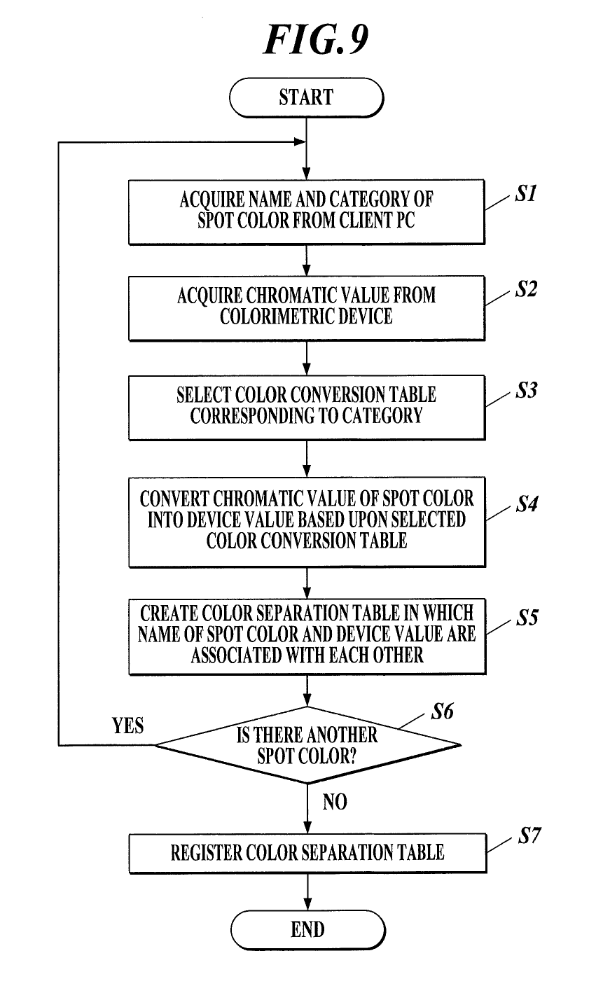

FIG. 9 is a flowchart illustrating a first color separation table creating process executed by the printer controller 20. This process is one example of the case where the color separation table is created based upon the name, chromatic value, and category of the spot color input by a user. This process is realized by a software process by collaboration between the CPU 21 and the program stored in the ROM 22.

Firstly, the user inputs the name of a spot color and the category of the spot color, which should be registered, through the operation unit 15 of the client PC 10. The input name and category of the spot color are transmitted to the printer controller 20 through the network IF unit 17 by the CPU 11. The printer controller 20 acquires the name and category of the spot color from the client PC 10 by the CPU 21 through the network IF unit 25 (step S1). The acquired name and category of the spot color are stored in the RAM 23 by the CPU 21.

The colorimetric device 40 measures the chromatic value of the print sample of the spot color ink, and the CPU 21 acquires the chromatic value of the spot color through the colorimetric device IF unit 26 (step S2). In the present embodiment, the value expressed by a color system of L*a*b* is used as the chromatic value. However, a value expressed by another color system may be used. The acquired chromatic value of the spot color is stored in the RAM 23 by the CPU 21. The user may input the chromatic value through the operation unit 15 of the client PC 10.

Then, the CPU 21 selects a color conversion table corresponding to the category of the spot color acquired in step S1 out of the plurality of color conversion tables (color conversion table for fluorescent colors 241, color conversion table for metallic colors 242, and color conversion table for general spot colors 243) stored in the storage unit 24 (step S3).

The CPU 21 then converts the chromatic value (L*a*b*) of the spot color acquired in step S2 into a device value (CMYK value) based upon the color conversion table selected in step S3 (step S4).

Next, the CPU 21 allows the name of the spot color acquired in step S1 to be associated with the device value corresponding to the spot color acquired in step S4 so as to create the color separation table (see FIG. 8) (step S5).

When there is another spot color on which a color separation should be performed (step S6: YES), the CPU 21 returns to step S1, so as to repeat the processes in steps S1 to S5. When there is no spot color on which a color separation should be performed in step S6 (step S6: NO), the CPU 21 registers the created color separation table into the storage unit 24 (step S7).

The first color separation table creating process is thus ended.

When image data containing the spot color is output, it is checked whether the name of the spot color in the image data and one of the spot color names in the registered color separation table match with each other. When they match with each other, the color separation table is used to perform a conversion from the name of the spot color into the corresponding device value. Alternatively, a plurality of color separation tables may be stored, and the priority order among the color separation tables may be set.

As described above, according to the first embodiment, not only a color conversion table is switched between the color conversion table for process colors and the color conversion table for spot colors, but also spot colors are further classified into categories, and a color conversion table is switched depending on the category. Therefore, an appropriate color conversion can be executed on a spot color for each category.

Even for a fluorescent color or metallic color, which needs to be adjusted and corrected according to a conventional method, a desirable color conversion can be executed to attain a color close to its visual impression by using color conversion tables which reflect difference in characteristics caused by ink components. Further, since a color conversion table is prepared for each category, there is no chance that levels of brightness, contrast, or hue etc. of spot colors that are similar to each other in the same category might be reversed.

### Second Embodiment

A second embodiment to which the present invention is applied will next be described.

An image forming system in the second embodiment has a configuration same as that of the image forming system 1 in the first embodiment. Therefore, FIGS. 1 to 3 are used for illustrating the image forming system, and the same components will not repeatedly be described. The characteristic configuration and process of the second embodiment will be described below.

The storage unit 24 further stores a chromatic value reference table and a category identification table. In the chromatic value reference table, a “chromatic value” is associated with a “name of a spot color”. In the category identification table, a “category” is associated with “a name of a spot color”. It is preferable that names of typical spot colors of major representative ink manufacturers are written on the chromatic value reference table and the category identification table.

An operation in the second embodiment will be described next.

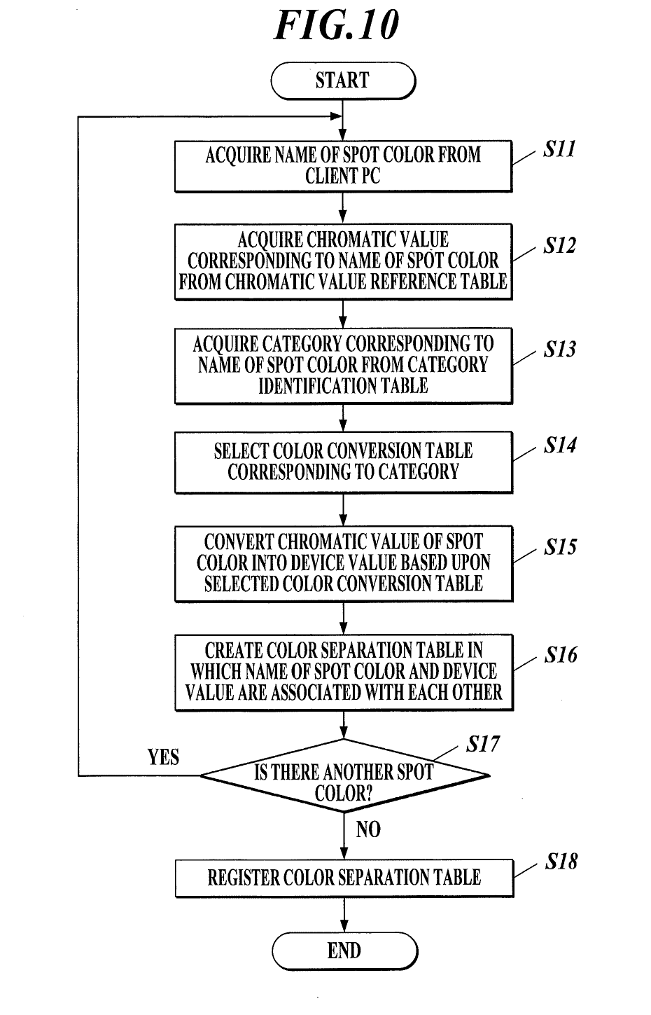

FIG. 10 is a flowchart illustrating a second color separation table creating process executed by the printer controller 20. This process is one example of the case where the color separation table is created by acquiring a corresponding chromatic value and category from the chromatic value reference table and the category identification table based upon the name of a spot color input by a user. This process is realized by a software process by collaboration between the CPU 21 and the program stored in the ROM 22.

Firstly, the user inputs the name of a spot color which should be registered through the operation unit 15 of the client PC 10. The input name of the spot color is transmitted to the printer controller 20 through the network IF unit 17 by the CPU 11. The printer controller 20 acquires the name of the spot color from the client PC 10 by the CPU 21 through the network IF unit 25 (step S11). The acquired name of the spot color is stored in the RAM 23 by the CPU 21.

Then, the CPU 11 refers to the chromatic value reference table stored in the storage unit 24 so as to acquire the chromatic value corresponding to the name of the spot color acquired in step S11 (step S12). The acquired chromatic value is stored in the RAM 23 by the CPU 21.

Then, the CPU 11 refers to the category identification table stored in the storage unit 24 so as to acquire the category corresponding to the name of the spot color acquired in step S11 (step S13). The acquired chromatic value is stored in the RAM 23 by the CPU 21.

Then, the CPU 21 selects a color conversion table corresponding to the category of the spot color acquired in step S13 out of the plurality of color conversion tables (color conversion table for fluorescent colors 241, color conversion table for metallic colors 242, and color conversion table for general spot colors 243) stored in the storage unit 24 (step S14).

The CPU 21 then converts the chromatic value (L*a*b*) of the spot color acquired in step S12 into a device value (CMYK value) based upon the color conversion table selected in step S14 (step S15).

Next, the CPU 21 allows the name of the spot color acquired in step S11 to be associated with the device value corresponding to the spot color acquired in step S15 so as to create the color separation table (see FIG. 8) (step S16).

When there is another spot color on which a color separation should be performed (step S17: YES), the CPU 21 returns to step S11, so as to repeat the processes in steps S11 to S16. When there is no spot color on which a color separation should be performed in step S17 (step S17: NO), the CPU 21 registers the created color separation table into the storage unit 24 (step S18).

The second color separation table creating process is thus ended.

As described above, according to the second embodiment, a color conversion table is switched depending on the category. Therefore, an appropriate color conversion can be executed on a spot color for each category.

As for a name of a spot color which is not written in the chromatic value reference table and the category identification table, a category and chromatic value of the spot color may be acquired from the client PC 10 or the colorimetric device 40, as in the first embodiment.

### Third Embodiment

A third embodiment to which the present invention is applied will next be described.

An image forming system in the third embodiment has a configuration same as that of the image forming system 1 in the first embodiment. Therefore, FIGS. 1 to 3 are used for illustrating the image forming system, and the same components will not repeatedly be described. The characteristic configuration and process of the third embodiment will be described below.

The CPU 21 acquires image data containing a name, category, and chromatic value of a spot color through the network IF unit 25; selects a color conversion table out of the plurality of color conversion tables stored in the storage unit 24, corresponding to the category of the spot color; and converts the chromatic value of the spot color into a device value based upon the selected color conversion table.

The printer IF unit 27 transmits the device value after the conversion to the printer 30.

An operation according to the third embodiment will next be described.

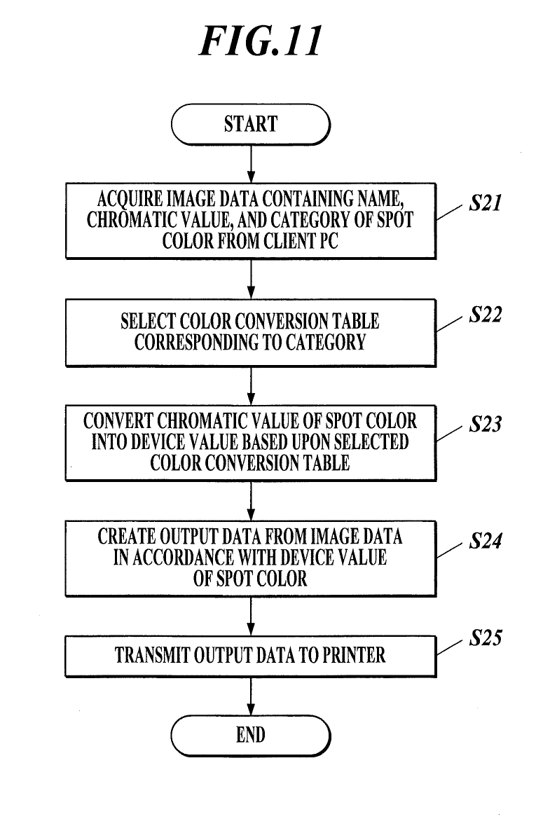

FIG. 11 is a flowchart illustrating a first color conversion process executed by the printer controller 20. This process is one example of the case where image data contains a name, chromatic value, and category of a spot color. The process is realized by a software process by collaboration between the CPU 21 and the program stored in the ROM 22.

When a user operates to issue a printing instruction through the operation unit 15 of the client PC 10, the CPU 11 transmits image data to the printer controller 20 through the network IF unit 17. This image data contains a name, chromatic value (defined as L*a*b*, and this value may be expressed by another color system), and category (including three types: fluorescent colors, metallic colors, and general spot colors) of the spot color used in the image data. The printer controller 20 acquires the image data containing the name, chromatic value, and category of the spot color from the client PC 10 by the CPU 21 through the network IF unit 25 (step S21). The acquired image data is stored in the RAM 23 by the CPU 21.

Then, the CPU 21 selects a color conversion table corresponding to the category contained in the image data acquired in step S21 out of the plurality of color conversion tables (color conversion table for fluorescent colors 241, color conversion table for metallic colors 242, and color conversion table for general spot colors 243) stored in the storage unit 24 (step S22).

The CPU 21 then converts the chromatic value (L*a*b*) of the spot color contained in the image data acquired in step S21 into a device value (CMYK value) based upon the color conversion table selected in step S22 (step S23).

The CPU 21 converts a portion of the spot color in the image data acquired in step S21 into a device value in accordance with the device value corresponding to the spot color obtained in step S23, thereby creating output data (step S24).

The CPU 21 then transmits the output data to the printer 30 through the printer IF unit 27 (step S25).

Thus, the first color conversion process is ended.

The printer 30 receives the output data, and forms an image containing the spot color based upon the output data.

As described above, according to the third embodiment, a color conversion table is switched depending on the category. Therefore, an appropriate color conversion can be executed on a spot color for each category.

### Fourth Embodiment

A fourth embodiment to which the present invention is applied will next be described.

An image forming system in the fourth embodiment has a configuration same as that of the image forming system 1 in the first embodiment. Therefore, FIGS. 1 to 3 are used for illustrating the image forming system, and the same components will not repeatedly be described. The characteristic configuration and process of the fourth embodiment will be described below.

As in the second embodiment, the storage unit 24 stores the chromatic value reference table and the category identification table.

The CPU 21 acquires image data containing a name of a spot color through the network IF unit 25, acquires a chromatic value corresponding to the name of the spot color by referring to the chromatic value reference table in the storage unit 24, and acquires a category corresponding to the name of the spot color by referring to the category identification table in the storage unit 24. The CPU 21 selects a color conversion table corresponding to the category of the spot color out of the plurality of color conversion tables stored in the storage unit 24, and converts the chromatic value of the spot color into a device value based upon the selected color conversion table.

The printer IF unit 27 transmits the converted device value to the printer 30.

An operation in the fourth embodiment will be described next.

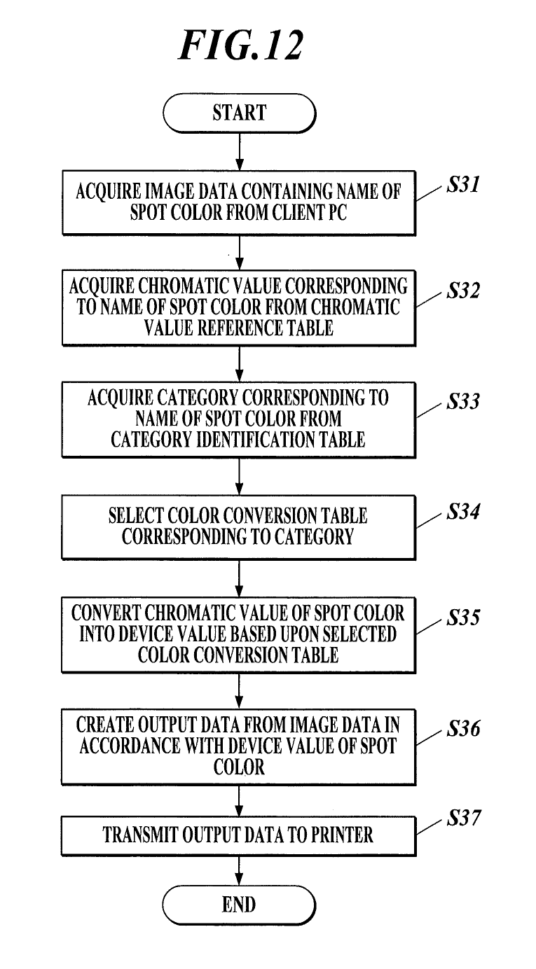

FIG. 12 is a flowchart illustrating a second color conversion process executed by the printer controller 20. This process is one example of the case where image data contains a name of a spot color. The process it is realized by a software process by collaboration between the CPU 21 and the program stored in the ROM 22.

When a user operates to issue a printing instruction through the operation unit 15 of the client PC 10, the CPU 11 transmits image data to the printer controller 20 through the network IF unit 17. This image data contains a name of the spot color used in the image data. The printer controller 20 acquires the image data containing the name of the spot color from the client PC 10 by the CPU 21 through the network IF unit 25 (step S31). The acquired image data is stored in the RAM 23 by the CPU 21.

Then, the CPU 11 refers to the chromatic value reference table stored in the storage unit 24 so as to acquire the chromatic value corresponding to the name of the spot color contained in the image data acquired in step S31 (step S32). The acquired chromatic value is stored in the RAM 23 by the CPU 21.

Then, the CPU 11 refers to the category identification table stored in the storage unit 24 so as to acquire the category corresponding to the name of the spot color contained in the image data acquired in step S31 (step S33). The acquired category is stored in the RAM 23 by the CPU 21.

Then, the CPU 21 selects a color conversion table corresponding to the category acquired in step S33 out of the plurality of color conversion tables (color conversion table for fluorescent colors 241, color conversion table for metallic colors 242, and color conversion table for general spot colors 243) stored in the storage unit 24 (step S34).

The CPU 21 then converts the chromatic value (L*a*b*) of the spot color acquired in step S32 into a device value (CMYK value) based upon the color conversion table selected in step S34 (step S35).

The CPU 21 converts a portion of the spot color in the image data acquired in step S31 into a device value in accordance with the device value corresponding to the spot color obtained in step S35, thereby creating output data (step S36).

The CPU 21 then transmits the output data to the printer 30 through the printer IF unit 27 (step S37).

Thus, the second color conversion process is ended.

The printer 30 receives the output data, and forms an image containing the spot color based upon the output data.

As described above, according to the fourth embodiment, a color conversion table is switched depending on the category. Therefore, an appropriate color conversion can be executed on a spot color for each category.

The detailed configuration of each unit constituting each apparatus and detailed operation illustrated in the embodiments can be modified without departing from the scope of the present invention.

For example, the above-mentioned embodiments describe the case in which a general spot color (a spot color other than a fluorescent color and metallic color) is used as the “predetermined spot color”. However, which color is specified as the “predetermined spot color” is a design matter, and can optionally be set by a user.

The entire disclosure of Japanese Patent Application No. 2010-254484 filed on Nov. 15, 2010 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A color conversion method that converts a spot color into a combination of a plurality of output-color values corresponding to output colors generated by an image forming apparatus, the method comprising:
acquiring a name of the spot color; a category of the spot color, the category being one of a plurality of categories into which spot colors are classified; and an input-color value of the spot color; for each spot color;
selecting a color conversion table corresponding to the acquired category out of a plurality of color conversion tables stored beforehand in a storage unit for the respective categories, each of the color conversion tables indicating a correspondence relationship between the input-color value and the combination of the output-color values; and
converting the acquired input-color value into the combination of the output-color values based upon the selected color conversion table.

2. The color conversion method according to claim 1, wherein the category includes a category composed of a fluorescent color and a category composed of a metallic color.

3. The color conversion method according to claim 1, wherein at least one of brightness and hue of a color, which is generated by the image forming apparatus based upon the combination of the output-color values obtained by converting the same input-color value, is different within a predetermined color range depending on which of the color conversion tables is used.

4. The color conversion method according to claim 1,
wherein the category includes a category composed of a fluorescent color and a category composed of a predetermined spot color, and
wherein a color conversion is performed such that brightness of a first color is higher than brightness of a second color within a predetermined color range, the first color obtained by using a color conversion table corresponding to the fluorescent color, the second color obtained by using a color conversion table corresponding to the predetermined spot color, and both of the first color and the second color generated by the image forming apparatus based upon the combination of the output-color values obtained by converting the same input-color value.

5. The color conversion method according to claim 1,
wherein the category includes a category composed of a fluorescent color and a category composed of a predetermined spot color, and
wherein a color conversion is performed such that a hue angle of a first color is larger than a hue angle of a second color within a predetermined color range, the first color obtained by using a color conversion table corresponding to the fluorescent color, the second color obtained by using a color conversion table corresponding to the predetermined spot color, and both of the first color and the second color generated by the image forming apparatus based upon the combination of the output-color values obtained by converting the same input-color value.

6. The color conversion method according to claim 1,
wherein the category includes a category composed of a metallic color and a category composed of a predetermined spot color, and
wherein a color conversion is performed such that brightness of a first color is higher than brightness of a second color within a predetermined color range, the first color obtained by using a color conversion table corresponding to the metallic color, the second color obtained by using a color conversion table corresponding to the predetermined spot color, and both of the first color and the second color generated by the image forming apparatus based upon the combination of the output-color values obtained by converting the same input-color value.

7. The color conversion method according to claim 1, wherein the output colors generated by the image forming apparatus are cyan, magenta, yellow, and black.

8. A color conversion apparatus that converts a spot color into a combination of a plurality of output-color values corresponding to output colors generated by an image forming apparatus, the color conversion apparatus comprising:
a storage unit that stores a plurality of color conversion tables for a plurality of categories, into which spot colors are classified, each of the color conversion tables indicating a correspondence relationship between an input-color value and the combination of the output-color values; and
a control unit that acquires a name of the spot color, a category of the spot color, and the input-color value of the spot color, for each spot color; selects a color conversion table corresponding to the acquired category out of the plurality of color conversion tables stored in the storage unit; and converts the acquired input-color value into the combination of the output-color values based upon the selected color conversion table.

9. The color conversion apparatus according to claim 8, wherein the category includes a category composed of a fluorescent color and a category composed of a metallic color.

10. The color conversion apparatus according to claim 8, wherein at least one of brightness and hue of a color, which is generated by the image forming apparatus based upon the combination of the output-color values obtained by converting the same input-color value, is different within a predetermined color range depending on which of the color conversion tables is used.

11. The color conversion apparatus according to claim 8,
wherein the category includes a category composed of a fluorescent color and a category composed of a predetermined spot color, and
wherein a color conversion is performed such that brightness of a first color is higher than brightness of a second color within a predetermined color range, the first color obtained by using a color conversion table corresponding to the fluorescent color, the second color obtained by using a color conversion table corresponding to the predetermined spot color, and both of the first color and the second color generated by the image forming apparatus based upon the combination of the output-color values obtained by converting the same input-color value.

12. The color conversion apparatus according to claim 8,
wherein the category includes a category composed of a fluorescent color and a category composed of a predetermined spot color, and
wherein a color conversion is performed such that a hue angle of a first color is larger than a hue angle of a second color within a predetermined color range, the first color obtained by using a color conversion table corresponding to the fluorescent color, the second color obtained by using a color conversion table corresponding to the predetermined spot color, and both of the first color and the second color generated by the image forming apparatus based upon the combination of the output-color values obtained by converting the same input-color value.

13. The color conversion apparatus according to claim 8,
wherein the category includes a category composed of a metallic color and a category composed of a predetermined spot color, and
wherein a color conversion is performed such that brightness of a first color is higher than brightness of a second color within a predetermined color range, the first color obtained by using a color conversion table corresponding to the metallic color, the second color obtained by using a color conversion table corresponding to the predetermined spot color, and both of the first color and the second color generated by the image forming apparatus based upon the combination of the output-color values obtained by converting the same input-color value.

14. An image forming system comprising:
an image forming apparatus; and
a color conversion apparatus that converts a spot color into a combination of a plurality of output-color values corresponding to output colors generated by the image forming apparatus, the color conversion apparatus comprising:
a storage unit that stores a plurality of color conversion tables for a plurality of categories, into which spot colors are classified, each of the color conversion tables indicating a correspondence relationship between an input-color value and the combination of the output-color values;
a control unit that acquires a name of the spot color, a category of the spot color, and the input-color value of the spot color, for each spot color; selects a color conversion table corresponding to the acquired category out of the plurality of color conversion tables stored in the storage unit; and converts the acquired input-color value into the combination of the output-color values based upon the selected color conversion table; and
a transmission unit that transmits the combination of the output-color values after a color conversion to the image forming apparatus.

15. The image forming system according to claim 14, wherein the category includes a category composed of a fluorescent color and a category composed of a metallic color.

16. The image forming system according to claim 14, wherein at least one of brightness and hue of a color, which is generated by the image forming apparatus based upon the combination of the output-color values obtained by converting the same input-color value, is different within a predetermined color range depending on which of the color conversion tables is used.

17. The image forming system according to claim 14,
wherein the category includes a category composed of a fluorescent color and a category composed of a predetermined spot color, and
wherein a color conversion is performed such that brightness of a first color is higher than brightness of a second color within a predetermined color range, the first color obtained by using a color conversion table corresponding to the fluorescent color, the second color obtained by using a color conversion table corresponding to the predetermined spot color, and both of the first color and the second color generated by the image forming apparatus based upon the combination of the output-color values obtained by converting the same input-color value.

18. The image forming system according to claim 14,
wherein the category includes a category composed of a fluorescent color and a category composed of a predetermined spot color, and
wherein a color conversion is performed such that a hue angle of a first color is larger than a hue angle of a second color within a predetermined color range, the first color obtained by using a color conversion table corresponding to the fluorescent color, the second color obtained by using a color conversion table corresponding to the predetermined spot color, and both of the first color and the second color generated by the image forming apparatus based upon the combination of the output-color values obtained by converting the same input-color value.

19. The image forming system according to claim 14,
wherein the category includes a category composed of a metallic color and a category composed of a predetermined spot color, and
wherein a color conversion is performed such that brightness of a first color is higher than brightness of a second color within a predetermined color range, the first color obtained by using a color conversion table corresponding to the metallic color, the second color obtained by using a color conversion table corresponding to the predetermined spot color, and both of the first color and the second color generated by the image forming apparatus based upon the combination of the output-color values obtained by converting the same input-color value.
